(19) United States
(12) Patent Application Publication
(10) Pub. No.: US 2007/0168720 A1
(43) Pub. Date: Jul. 19, 2007

(54) Method and apparatus for providing fault tolerance in a collaboration environment

(75) Inventors: Ramkrishna Chatterjee, Nashua, NH (US); Gopalan Arun, Nashua, NH (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, WESTBOROUGH, MA, 01581, US

(73) Assignee: ORACLE INTERNATIONAL CORPORATION, REDWOOD SHORES, CA (US)

(21) Appl. No.: 11/291,351

(22) Filed: Nov. 30, 2005

(51) Int. Cl. G06F 11/00

(52) U.S. Cl. 714/15

(57) ABSTRACT

A fault processor in a collaboration server models collaborative operations as a state machine. The fault processor divides collaboration operations into discrete segments, in which each segment corresponds to a repository update. A state definition defines the progression of states between the segments, and defines transitions to recovery states in the event of unexpected interruption. A state log maintains the completion status of each segment in the operation, and recovery logic employs the state log to perform recovery of an abnormally terminated operation. The recovery logic computes the segments to be performed in a recovery. Compatibility logic selectively prohibits operations which may affect or be affected by inconsistencies presented prior to successful recovery. In this manner, collaboration software defined according to configurations herein identifies failures, implements recovery based on a state machine corresponding to segments of an operation, and preserves consistency by recovering the incremental segments defined by the states.

### BACKGROUND

In a modern information processing environment, a group of users often work together toward a common goal in a collaboration environment. A typical scenario occurs in an employment context between employees in a project group, for example. A project group often delegates tasks to individual members, and then reviews and aggregates the results that individual members produce into an integrated group product, document, application, or other aggregate output. Therefore, the project group often operates as a collaboration group, such that the collective efforts of the group may be aggregated into a whole as a finished product of the collaboration group.

The individual contributions by group members may be in a variety of forms, such as documents, code, figures, charts, memos, notes, and designs, for example. Often these contributions are electronically generated and modified by a variety of software applications, such as word processors, compilers, graphical tools, email, calendar tools, schedulers and the like, and are stored as a particular type of file, document or other data. Managing and coordinating the different contributions from the collaboration group typically involves ensuring that changes and additions made by each user are accessible to other users and not overwritten by other users. Accordingly, a conventional collaboration group work environment often employs a number of administrative tools and aids for providing operations such as configuration management, revision libraries, concurrency controls, and version tracking, to name several, for ensuring preservation of the collective group effort.

### SUMMARY

A collaboration environment facilitates the aggregation of individual efforts toward a common group goal. Such a collaboration environment serves to retain and consolidate individual contributions for usage toward the group effort, and manages administrative functions so as to allow group access to the work product, while also handling concurrency issues which may result in redundant or mitigation of group efforts, such as accidental overwrites and duplicate updates. A typically collaboration environment exists in an employment context, where employee groups work toward a common product, release, document, design or subsystem, for example. Collaboration software supporting the collaboration environment coordinates access and storage of the files and objects that are representative of the group work product.

Embodiments disclosed herein operate in a software based collaboration environment. In such an environment, a collaboration group of users coordinates and aggregates efforts through a common collaborative workspace via collaborative access to a set of independently operable software applications such as an email application, a file system application, a calendar application, a threaded discussion application, or other applications that are selectable for inclusion into the collaborative workspace. In general, the collaborative workspace allows users to access the set of independently operable software applications and coordinates contributions of individual users such that the common collaborative workspace effectively aggregates the collective effort of the collaboration group.

Configurations of the invention are based in part on the observation that, in a collaboration environment, as in any managed information environment, unexpected failures and ungraceful terminations need to be anticipated. Events such as power failures, human error, network interruptions, hardware malfunction and data corruption should be anticipated in a robust site management plan. Collaboration operations, however, typically involve updates to multiple repositories. For example, an operation may involve changes to a user directory repository, a collaboration group library, and various email repositories (mailboxes). Accordingly, in the collaboration environment, collaboration operations typically involve multiple repository updates to complete. Typically, the integrity and consistency of the collaboration work product (i.e. the collection of files or objects representing the work product) relies on the atomicity of the multiple repository updates.

Unfortunately, conventional mechanisms for fault detection in a collaboration environment suffer from several shortcomings. Such conventional mechanisms fail to adequately integrate recovery operations with the collaboration software. Accordingly, issues related to fault management in a distributed software environment for team collaboration have not been approached in a systematic manner. Typical conventional systems deal with these issues in an ad hoc manner, require the users to perform a number of manual steps and do not guarantee a high level of quality of service in the presence of faults. In a context of SQL based updates, typical in a collaboration environment, protocols for accommodating distributed transactions, as in collaboration software, have been pursued. However, direct usage in a collaboration team environment is problematic because the conventional collaboration software does not implement distributed recovery protocols. Therefore, manual user intervention and modifications are typically employed to implement fault processing for backing out or performing piecemeal completion of unfinished collaboration operations.

Accordingly, configurations herein substantially overcome the above described shortcomings by modeling collaborative operations as a state machine. In the exemplary configuration, a fault processor divides collaboration operations into discrete segments, in which each segment corresponds to a repository. The exemplary state machine employed herein is linear, however more complex transitional branching may be performed in alternate configurations. Each segment, therefore, represents a portion of the entire collaborative operation. A state machine definition defines the progression of states between the segments (i.e., state transitions), and defines completion states and recovery transitions to be executed in the event of unexpected interruption.

In further detail, in the exemplary configuration discussed herein, depending upon the current state, the operation recovery logic decides which path to take in case of failure. In the exemplary configuration, for each operation, a fault processor registers a Java class that implements recovery logic for the operation. Recovery logic calls a specific method in this class when a fault is detected for this operation and recovery needs to be performed. The logic for which path to take is in this method. Also note that the recovery process need not be executed immediately after failure. For example, the system may crash and then the application admin decides to start the recovery process at a suitable time after the system is restarted. A state log maintains the completion status of each segment (more specifically, it stores information about each state transition) in the operation, and recovery logic employs the state log to perform recovery of an abnormally terminated operation. Recovery may be either based on a rollback to back out changes made by the operation, or may be completion based, to enumerate and perform remaining updates. The recovery logic computes the states and compensation events to be performed in a recovery, and considers the current state relative to completion of the operation, the magnitude of compensation events to back out and rollback the operation, and the status of previous segments (states) stored in a state log. Depending upon the information in the state log the recovery logic may either decide to rollback or complete the operation, as will be discussed further below. Compatibility logic identifies operations which may affect or be affected by inconsistencies presented prior to successful recovery, and selectively prohibits such operations until recovery is completed. In this manner, collaboration software defined according to configurations herein identifies failures, implements recovery based on a state machine corresponding to segments (or steps) of an operation, and preserves atomicity by recovering the incremental segments defined by the states.

In conventional approaches, the above issues related to fault management in a distributed software environment for team collaboration have not been explored in a systematic manner. Conventional systems deal with these issues in an ad hoc manner. These systems force the users to perform a number of manual steps for recovering the system from a fault. Further, conventional protocols (e.g., 2 PC) for managing distributed SQL-transactions cannot be directly used in a distributed environment for team collaboration because most of the conventional collaborative resources operable upon in such an environment do not implement these protocols.

In the scheme presented herein, the system may be recovered by invoking a single procedure that performs recovery by scanning the state log. In contrast, in conventional systems, there is no systematic way to minimize further faults and ensure correctness of further operations after a fault occurs. Rather, configurations herein provide a flexible scheme for fault tolerance that uses an operation compatibility matrix and an operation (e.g. state) log. This scheme minimizes further faults and ensures correctness of further operations after a fault occurs.

In further detail, the method of performing fault tolerance in a collaboration environment according to principles of the invention includes identifying a plurality of segments of an operation, such that each segment is indicative of partial completion of the operation, and defining a state corresponding to each segment. Each of the segments corresponds to an update to a particular repository from among the plurality of repositories included in the operation. The collaboration server performs each of the segments in the order defined by the states, and transitions to a recovery state if performance of a segment results in an incomplete result, as indicated by faults collected by a fault collector. The fault processor in the collaboration server includes recovery logic operable to identify, from a particular current state, a transition state for advancement by registering a Java class for each operation which includes recovery logic for the operation). Identifying the transition state further includes storing a current state, and referencing a state definition indicative of the next state based on a particular current state.

The recovery logic updates a state log upon completion of each segment (state), and transitions to the referenced next state by storing state transitions and optional information specific to the particular execution of the operation, (e.g., path of the library to be created). Therefore, the recovery state machine encompasses defining a plurality of states corresponding to segments, such that the segments are indicative of predetermined demarcations of a portion of the entire operation. The predetermined demarcations each represent successive partial completion of the operation. Partial completion is indicative of storing the updates in a subset of a plurality of repositories corresponding to the entire operation. In particular configurations, the state log and the workspace metadata repository may be maintained in the same database and hence storing the state log and the update corresponding to the segment for workspace metadata repository update can be done in a single SQL transaction. In an exemplary configuration, performing the segments further includes writing to a state log. The state log is operable to identify the state of the operation as at least one of “successfully completed,” “just failed” and “ongoing.” Recovery logic is operable to identify a state definition indicative of, for each state, a next state for success and failure transitions, thus including a failure transition corresponding to a “needs recovery” state. The state definition defines a deterministic state of the operation from each state based on the outcome of the previous state, as recorded in the log. Each of the segments corresponds to a repository update, such that performing the segment includes writing the corresponding update to the repository.

In particular configurations, transitioning to a recovery state further includes selecting between completion based recovery and rollback based recovery. Performing the rollback based recovery further includes reverting the last completed state, and performing a compensating step for each completed state to achieve consistency for the compensated step.

In the exemplary configuration, concurrency control is performed by, a compatibility matrix operable to identify compatible operations during normal and faulted (i.e. partially completed) operations. In the event of partial completion of an operation, compatibility logic identifies concurrent operations being attempted during recovery of a partial completion, and computes if the identified concurrent operation is compatible with the partial completion. The recovery logic selectively disallows the concurrent operation if it is not compatible with the partial completion. Alternate configurations of the invention include a multiprogramming or multiprocessing computerized device such as a workstation, handheld or laptop computer, cellphones or PDA device, or dedicated computing device or the like, configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a computer-readable medium including computer program logic encoded thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM or RAM or PROM chips, field programmable gate arrays (FPGAs) or as an Application Specific Integrated Circuit (ASIC). The software or firmware or other such configurations can be installed onto the computerized device (e.g., during operating system for execution environment installation) to cause the computerized device to perform the techniques explained herein as embodiments of the invention.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of an exemplary collaboration environment suitable for use with configurations discussed herein;

FIG. 2 is a flowchart of state based recovery in the collaboration environment of FIG. 1;

FIG. 3 is a block diagram of the fault processor in the collaboration server of FIG. 1 operable for recovery according to the sequence in FIG. 2;

FIGS. 4-7 are an exemplary sequence of recovery in the system of FIG. 3; and

FIG. 8 depicts concurrency control for concurrent operations in the system of FIG. 3.

### DETAILED DESCRIPTION

In a software environment for team collaboration, users collaborate using resources (or applications) that are distributed across multiple applications or repositories. As a result, operations frequently span multiple applications. For example, when a resource for discussion forums is added to a collaborative workspace, a container (called a discussion facility) is created in a discussions repository to group the forums created in the workspace. As a result, to complete the overall operation of adding the discussion resource, sub-operations have to be performed on both the discussion application as well as the repository for workspace metadata, which keeps track of the resources added to each workspace. Any one of these sub-operations can fail independently, causing the entire operation to fail. Since these sub-operations cannot be done in a single SQL-transaction (which ensures the ACID properties), when the overall operation fails, the workspace and discussion repositories can be left in an inconsistent state. For example, a container for the workspace exists in the discussion repository but the workspace metadata repository is not updated to record the inclusion of the resource, or vice versa. Unrestricted operation in the presence of such failures may cause further errors. Thus, a mechanism is needed to detect and recover from such faults. Moreover, after a failure occurs, restrictions to other operations should be mitigated. For instance, in the above example, only discussion related operations in the workspace should be restricted, but operations on other resources in the workspace should be allowed. Hence, it would be further beneficial to provide a mechanism to tolerate such faults and allow operations in their presence. This mechanism should be able to make a safe and accurate estimate of the set of operations that are affected by a fault. Further, concurrent operations by multiple users may lead to inconsistencies and faults. Accordingly, in a software environment for team collaboration, it would be beneficial to employ a mechanism to detect, recover from, tolerate and avoid faults.

The above issues related to fault management in a distributed software environment for team collaboration have not been approached in a systematic manner by the conventional systems. Conventional systems deal with these issues in an ad hoc manner, force the users to perform a number of manual steps and do not guarantee a high level of quality of service in the presence of faults. Conventional protocols such as Two Phase Commit (2 PC) for managing distributed SQL-transactions are not directly applicable to a distributed environment for team collaboration because most of the collaborative resources operable in such an environment do not implement these protocols.

By way of further background, the collaborative workspace referred to herein is employable for a variety of group efforts, using any of a plurality of available applications, for endeavors such as software development, document preparation and maintenance, design specifications, knowledge bases, and other collaborative undertakings in which a group of users focus their collective expertise on a solution or product. Further details and discussion on a collaboration workspace suitable for use with the fault management system disclosed herein are disclosed in co-pending U.S. patent application Ser. No. 11/______,______, filed Oct. __, 2005, entitled “METHODS AND APPARATUS PROVIDING COLLABORATIVE ACCESS TO APPLICATIONS” (Atty. Docket No. OID05-01(01201), the entire contents and teachings of which are hereby incorporated herein by reference in their entirety.

Exemplary configurations discussed herein model collaborative operations, adaptable to such a workspace, as a state machine. A fault processor in a collaboration server for managing workspaces divides collaboration operations into discrete segments, such that each segment corresponds to a repository update. Each segment, therefore, represents a portion of the entire operation. A state definition defines the progression of states between the segments, and defines transitions to recovery states in the event of unexpected interruption. A state log maintains the completion status of each segment in the operation, and recovery logic employs the state log to perform recovery of an abnormally terminated operation. Recovery may be either a rollback to back out changes made by the operation, or may be completion based, to enumerate and perform remaining updates; the approach is chosen based on the current information in the state log. The recovery logic computes the states and compensation events to be performed for a recovery using the current state relative to completion of the operation, the magnitude of compensation events to back out and rollback the operation, and the status of previous segments (states) stored in a state log. Compatibility logic identifies operations which may affect or be affected by inconsistencies presented prior to successful recovery, and selectively prohibits such operations until recovery is completed. (note recovery process may not have started and even then fault tolerance is provided using the same mechanism). In this manner, collaboration software defined according to configurations herein identifies failures, implements a recovery based on a state machine corresponding to segments of an operation, and preserves atomicity by recovering the incremental segments defined by the states.

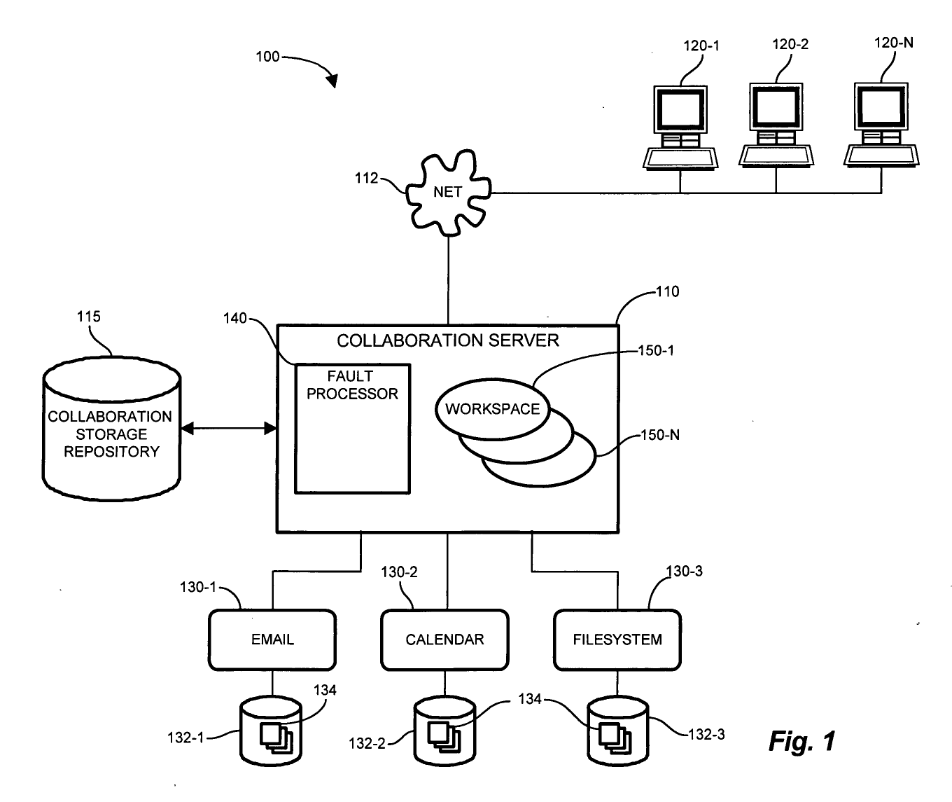

FIG. 1 is a context diagram of an exemplary collaboration environment 100 suitable for use with configurations discussed herein. Referring to FIG. 1, the collaboration environment 100 includes a collaboration server 110 having a fault processor 140 and a plurality of users 120-1.120-N (120 generally) interconnected via a network 112 such as the Internet, VPN, LAN, WAN or other packet switched interconnection medium. The server 110 includes one or more workspaces 150-1.150-N (150, generally) for providing collaborative access to a plurality of applications 130-1.130-3 (130 generally). The applications 130, therefore, provide services to the users 120 via the workspace 150 and the network 112. Each of the applications 130 has respective storage area repositories 132-1.132-3 (132 generally) for storing application data 134, therefore relieving the workspace 150 from storing the application data 134 on behalf of the users 120.

The workspace 150, therefore, includes metadata defining the application data 134 stored by the applications 130 on behalf of each user 120. Each of the workspaces defines a particular collaboration environment, including users 120, applications 130, and other metadata that defines the data and objects included in the workspace on behalf of the collaboration group. The server 110 also connects to a local collaboration storage repository 115, which is operable to store the workspace 150 as a template on a disk volume or other form of local collaboration storage 115. Further details on storage and retrieval of workspaces as templates may be found in copending U.S. patent application Ser. No. 11/______,______, filed Oct.__, 2005, entitled: “METHODS AND APPARATUS FOR DEFINING A COLLABORATIVE WORKSPACE” (Atty. Docket No. OID05-02(01301)).

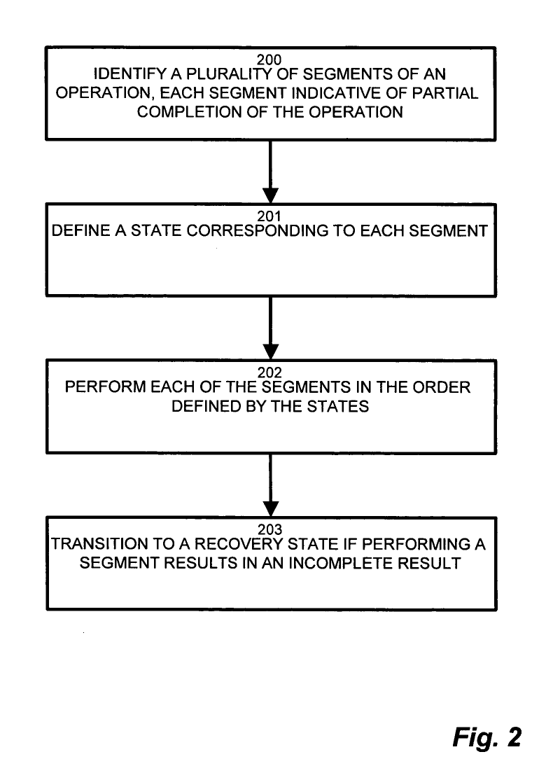

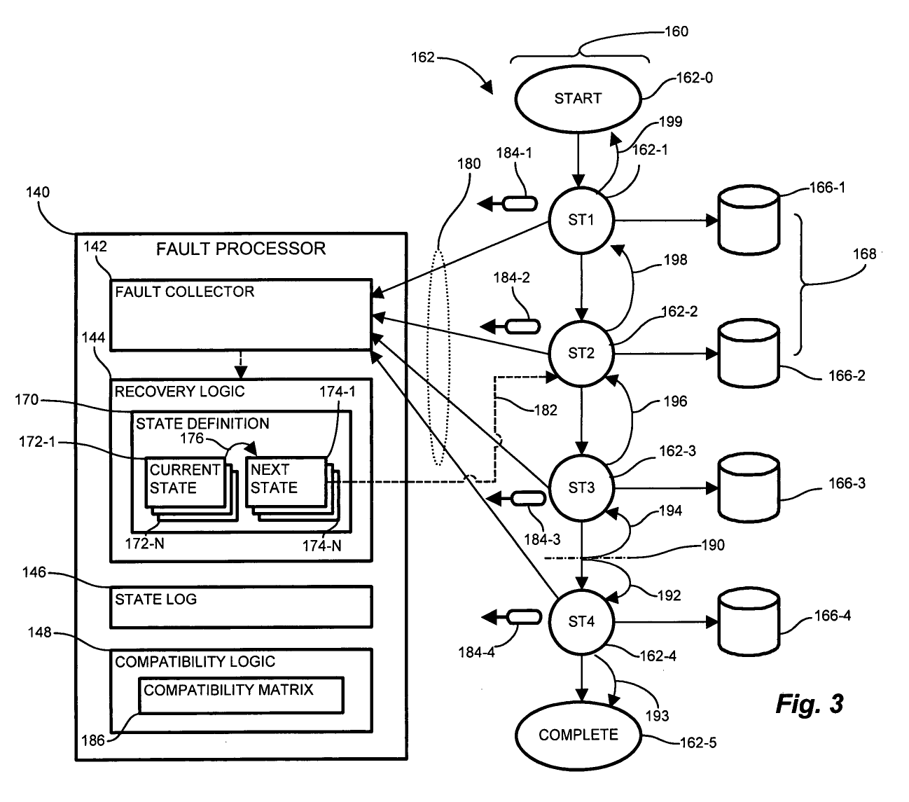

FIG. 2 is a flowchart of state based recovery in the collaboration environment of FIG. 1. Referring to FIGS. 1 and 2, the method of performing fault tolerance in a collaboration environment includes, at step 200, identifying a plurality of segments 168 of an operation 162 (FIG. 3, below), such that each segment 168 is indicative of partial completion of the operation. The segments 168 correspond to updates to a particular repository 115, 166, or to some portion thereof. The collective set of segments in the operation, therefore, represent the repository updates in the entire operation. At step 201, the fault processor defines a state corresponding to each segment 168. The states, therefore, define a state machine in which each state has a transition to a successive state for the successful completion and for a recovery state in the event of a fault. The collaboration server, at step 202, performs each of the segments in the order defined by the states, thus completing each of the repository updates in the event of normal (non-fault) execution of the entire operation 162. The fault collector, at step 203, transitions to a recovery state if performing a segment results in an incomplete result, deferring control to the recovery logic 144 for computing and executing recovery, discussed in further detail below.

FIG. 3 is a block diagram of a fault processor in the collaboration server of FIG. 1 operable for recovery according to the sequence in FIG. 2. Referring to FIGS. 1 and 2, the fault processor 140 includes a fault collector 142, recovery logic 144, a state log 146 and compatibility logic 148. An exemplary state diagram 160 depicts the states 162-1.162-4 (162 generally) of an operation 162 as ST1.ST4, bounded by initial (start) and completion states 162-0, 162-5, respectively. Each of the states 162 represents an update 164 to a particular repository 166-1.166-4, respectively. Similarly, the quantum of instructions defining a transition from one state 162-N to another is a segment 168.

The recovery logic 144 includes a state definition 170, which defines the state machine 160 models a particular operation 162. The state definition 170 defines the transitions 176 between states 162-N corresponding to each of the segments 168, shown as exemplary current states 172-1.172-N (172 generally) to next states 174-1.174-N, respectively. It will be apparent to those of skill in the art that the state machine 160 model may be represented by alternate implementations of state transitions, of a such as a digraph, matrix, ordered list, etc., also operable to identify states 162-N and conditions for transition 176.

In operation, the fault collector 142 identifies state transitions from each of the states 162-N, shown by arrows 180. The fault collector 142 is responsive to the recovery logic 144 for identifying a recovery situation, discussed further below, and for computing state transitions 176. The state definition 170 in the recovery logic 144 determines, for a reported current state 172, the corresponding next state 174. The recovery logic 144 is further operable to defer control to the computed state 162, as shown by arrow 182. The recovery logic 144 selectively computes next states 174 based on the current state 172, a completion status 184 of the current state, and a history of previous states in the state log 146. Further, the compatibility logic 148 employs a compatibility matrix 186 indicative of concurrency of operations with recovery. If the recovery logic 144 identifies an incomplete status 184, the compatibility matrix 186 indicates other operations which are permitted or blocked based on the state 162-N, because incomplete segments may result in an inconsistent state that may cause certain operations to execute improperly.

Each of the states 162 corresponds to one or more updates (writes) to a repository 166. If the fault collector 142 detects an incomplete, erroneous, or malfunction in a state 162-N, then less than all repository updates 164-1.164-N included in an operation have completed. Accordingly, the fault processor 140 commences recovery by transitioning to recovery states to either rollback or complete the operation to a point of consistency. For example, if a fault occurs at a point denoted by line 190, ST4 cannot be transitioned to because the segment preceding it failed and accordingly, the fault processor 140 initiates a recovery. Recovery may be completion based, shown by arrow 192, in which the repository updates 164 are brought toward a completion state 162-5, or rollback based, shown by arrow 194, in which the repository updates 164 are backed out. In the case of a rollback, the recovery logic 144 performs compensating steps to back out updates 164 of previous segments 168, shown by arrows 196 and 198.

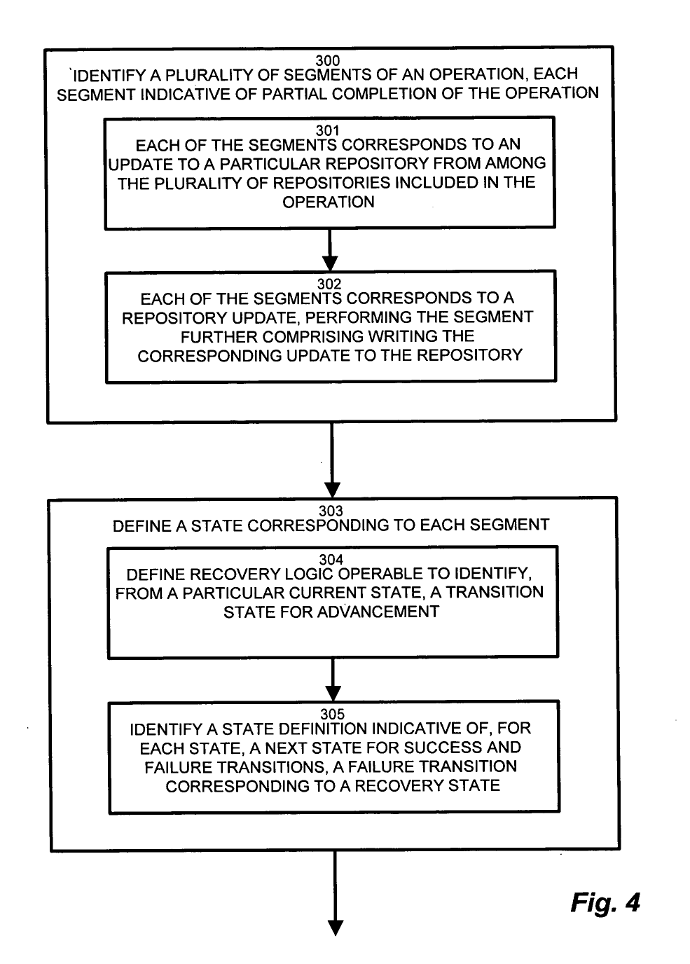

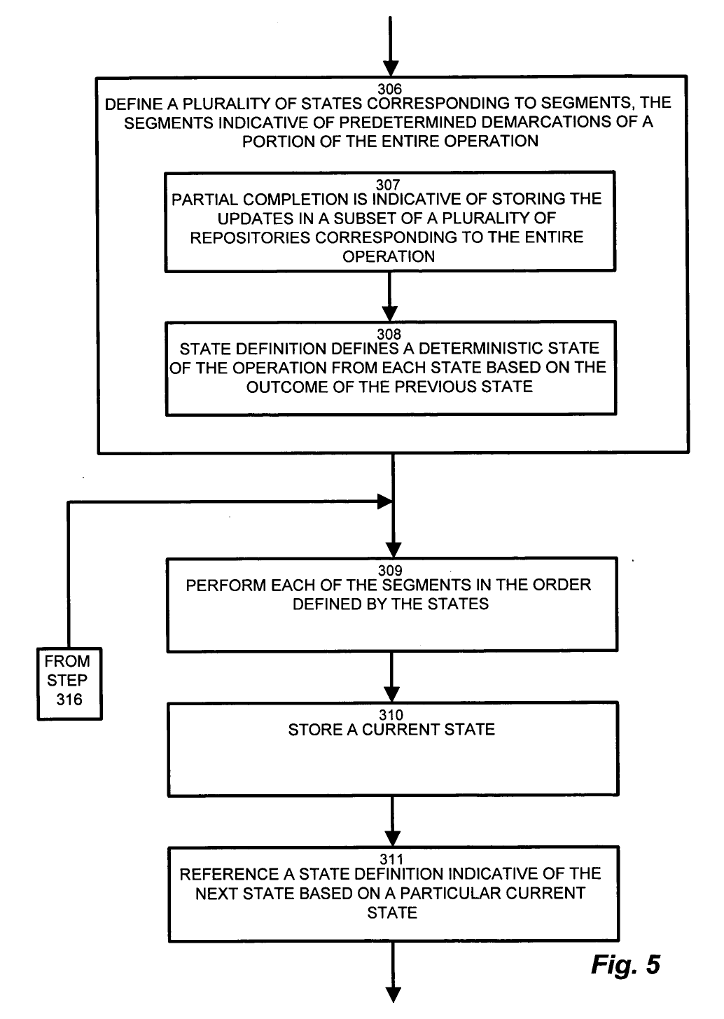

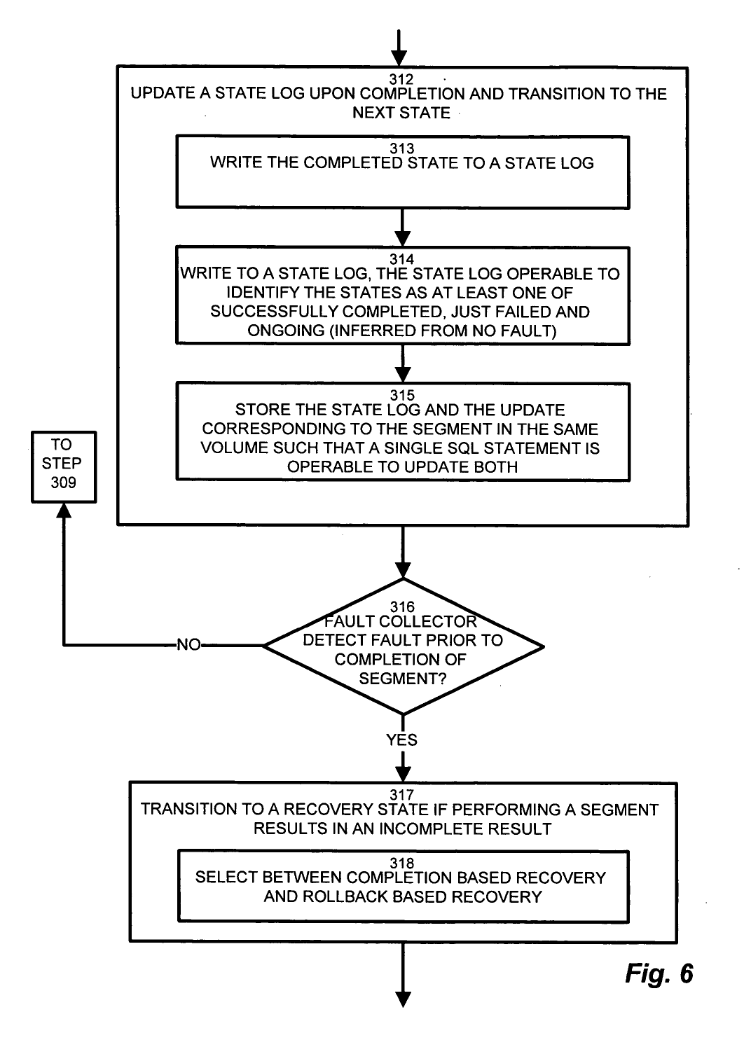

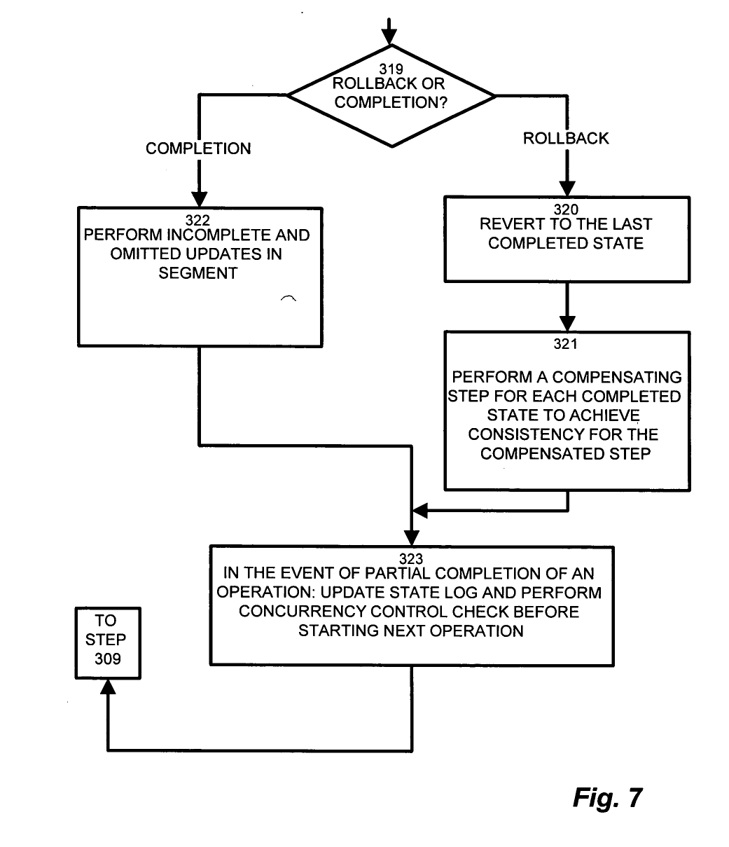

FIGS. 4-7 are an exemplary sequence of recovery in the system of FIG. 3. Referring to FIGS. 3-7, at step 300, the disclosed method of performing fault tolerance in a collaboration environment includes identifying a plurality of segments of an operation, in which each segment is indicative of partial completion of the operation 162. Each of the segments 168 corresponds to an update to a particular repository from among the plurality of repositories 166 included in the operation, as depicted at step 301. Therefore, each segment 168 generally represents a write or update to a repository 166, typically a relational database table. Completion of each of the segments 168 includes writing the corresponding update to the repository 166, as depicted at step 302.

The fault processor 140 defines a state 162-N corresponding to each segment 168, as shown at step 303. A user or process defines recovery logic 144 operable to identify, from a particular current state, a transition state for advancement, as depicted at step 304. The recovery logic 144 identifies recovery states for execution in the event of fault detection with the positive state path. Accordingly, the fault processor 140 identifies a state definition indicative of, for each state 162-N, a next state 174 for success and failure transitions, such that a failure transition corresponds to a recovery state, as depicted at step 305.

Having identified transitions 176 for each segment 168, the fault processor 170 generates a state definition 170 for the entire operation 162, including defining a plurality of states 162-N corresponding to segments 168, such that the segments 168 are indicative of predetermined demarcations of a portion of the entire operation, as depicted at step 306. The predetermined demarcations are indicative of partial completion of the operation 162, which is defined by storing the updates in a subset of a plurality of repositories 166 corresponding to the entire operation 162, as disclosed at step 307. Accordingly, at step 308, the state definition 170 defines a deterministic state 162-N of the operation 162 from each state based on the outcome of the previous state. Thus, the state definition 170 includes, for each state (current state) 172-N, a corresponding next state 174-N, depending on the success or fault status of a particular current state 172. A robust fault tolerant scheme addresses an appropriate transition to a recovery state for each repository 166 update which may encounter a fault, or failure to complete. The deterministic state definition ensures a transition from each current state 172 corresponding to a particular outcome from the segment defining the state.

The collaboration server 110, under the scrutiny of the fault processor 140, performs each of the segments 168 in the order defined by the states 162-N, as depicted at step 309. At completion of each state, the fault processor 140 stores the current state 172 in the state log 146, to mark the progression of the portions (i.e. segments) of the entire operation, as shown at step 310. For each state 162-N, the fault processor 140 references a state definition 170 indicative of the next state 174 based on a particular current state 172, as depicted at step 311. The recovery logic 144 updates the state log 146 upon completion and transition to the next state 174, as shown at step 312. Upon completion, at step 313, the recovery logic 144 writes the completed state 162-N to the state log 146, as shown at step 314. Successful performance of each of the segments 168 further includes, therefore, writing to the state log 146 such that the state log 146 is operable to identify the states as at least one of 1) successfully completed, 2) just failed, or 3) ongoing, as shown at step 314, for facilitating a restarting point during any subsequent recovery. Note that in the exemplary configuration, the “ongoing” state is inferred from the log. Generally, on successful completion, the log entries for the operation are deleted, such that if there is no needs_recovery entry in the log and the operation has not timed out, then the operation is considered to be ongoing. Further, the fault processor 140 may store the state log 146 and the update corresponding to the segment 168 (i.e. the repository update of the segment) in the same volume 115 such that a single SQL statement is operable to update both, as depicted at step 315.

For each step, the fault collector 142 performs a check to determine if a fault has occurred, as depicted at step 316. If segment 168 completion was successful, control reverts to step 309 for the next segment 168 in the operation. If a fault was encountered, the fault collector detects a fault signal 180 from the corresponding instructions (state) 162. Accordingly, the recovery logic 144 transitions to a recovery state if performing a segment 168 results in an incomplete result, indicating that a fault has occurred, as shown at step 317.

Upon transitioning to a recovery state, the recovery logic 144 selects between completion based recovery and rollback based recovery, as depicted at step 318. At step 319, a check is performed to determine if completion based or rollback recovery is performed. Completion based recovery is directed at completing the unfinished or omitted repository updates, if the operation 162 was sufficiently complete to enable the recovery logic 144 to identify the remaining segments 168. Rollback occurs if the operation 162 cannot be completed in entirety, and therefore backs out the segments 168 already performed to revert to pre-operation status of each repository 166. A particular feature facilitated by the modeling of the operation as a finite state machine provides that the recovery logic may employ a combination of rollback based and completion based schemes. For example, depending upon the current state of the operation, it may undo/rollback/compensate a few of the completed steps and then execute steps required to reach a completion state. This can happen for a non-linear state machine. Accordingly, at step 320, if rollback recovery is selected, rollback based recovery includes reverting to the last completed state 162-N, and performing a compensating step for each completed state 162-N to achieve consistency for the compensated step, as depicted at step 321. Referring to FIG. 3, for example, if a fault occurs at the time indicated by line 190, rollback based recovery attempts first to reverse the segment in progress, as shown by arrow 194. The recovery logic then performs compensating steps 196, 198 and 199 to undo each previous segment 168 in the operation. Completion based recovery, shown by the arrow 192, completes the segment 168 in progress to advance to ST4 (state 4) 162-4 and then to the state COMPLETE, shown by arrow 193.

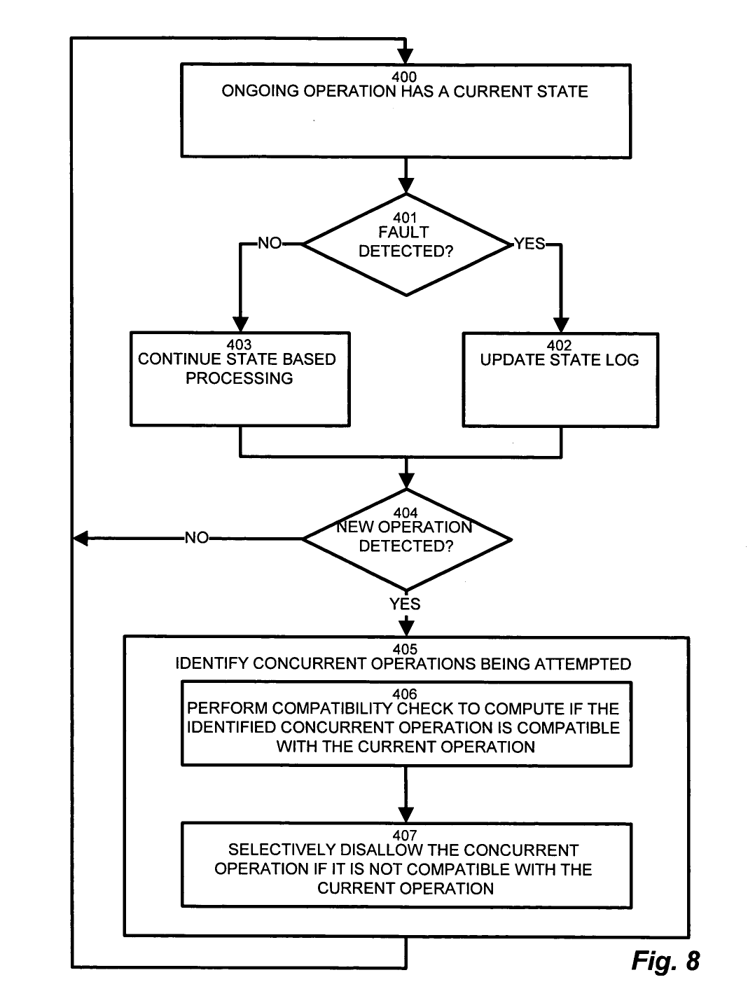

During recovery, when the various repositories 166 may not be in a consistent state with respect to each other, certain operations should be prevented from concurrent operation. While performing recovery, other operations are prevented if they rely on consistency between two or more repositories 166 left in an inconsistent state by the faulted operation 162. Accordingly, at step 323, in the event of partial completion of an operation, the state log 146 is updated and the concurrency check, depicted in further detail below with respect to FIG. 8, is performed prior to commencing new operations. Control then reverts to step 309 for successive operations.

FIG. 8 depicts concurrency control for concurrent operations in the system of FIG. 3. Concurrency control is parallel to the fault tolerance sequence discussed above with respect to FIGS. 4-7. Concurrency control is achieved by comparing the log of ongoing operations with the operation compatibility matrix and disallowing incompatible operations. Similar operations performed for failed operations, provide fault tolerance. Accordingly, FIG. 8 depicts fault tolerance and concurrency control to demonstrate how the operation compatibility matrix 186 is consulted. Note that for fault tolerance and concurrency control, steps executed during recovery are handled similar to steps of an ongoing operation.

Referring to FIGS. 8 and 3, at step 400, an ongoing operation has a current state in the state log 146. Concurrency control persists for incompatible operations, employing the state log 146 to identify the state of failed and ongoing operations and prevent incompatible operations in either case. Accordingly, at state 401, a check is performed to identify a fault in the ongoing operation, corresponding to the fault detection and recovery sequence of FIGS. 4-7. In the case of a fault, the state log 146 is updated, as shown at step 402, otherwise normal operation processing continues as depicted at step 403. A check is performed, at step 404, to identify new operations. Upon commencement of a new operation, at step 405, the compatibility logic 148 employs the compatibility matrix 186, discussed in further detail below, to determine compatible operations. Any faulted operations have an appropriate state as performed in step 402. Accordingly, the compatibility logic 148 identifies concurrent operations being attempted, either during normal processing or during recovery of partial completion of an operation (i.e. a faulted operation),or alternatively, until recovery is complete as stated above, depending on the updated state, as disclosed at step 403.

The compatibility logic 148 computes if the identified concurrent operation is compatible with the current (ongoing) operations, as depicted at step 406. In the exemplary configuration, a compatibility matrix 186 indicates, for each operation, other operations which are compatible with concurrent state of the faulted operation. Accordingly, based on the compatibility matrix 186, the compatibility logic 148 selectively disallows the concurrent operation if it is not compatible with the partial completion, as depicted at step 407. Control then reverts to step 400 for the next operation.

A further discussion of fault detection and the state transitions corresponding to the resource update example from above follows, with reference to FIGS. 1 and 3, and Table I, below. The fault processor 140 models each operation as a finite state machine Each operation 162 is divided into a fixed number of states, corresponding to a segment 168 of instructions, and a persistent log (state log) 146 is kept of the state transitions as the operation 162 proceeds through these states 162-N. This log 146 is consulted to detect faults and also to recover from them. For instance, one possible state transition diagram for the operation of adding a discussion resource to a workspace, discussed earlier, is as follows:
State 1: START_ADD_DISCUSSION_RESOURCE
State 2: START_STORE_RESOURCE_METADATA_IN_WORKSPACE_MEDATA_REPOSITORY
State 3: END_STORE_RESOURCE_METADATA_IN_WORKSPACE_MEDATA_REPOSITORY
State 4: START_CREATE_WORKSPACE_CONTAINER_IN_RESOURCE
State 5: END_CREATE_WORKSPACE_CONTAINER_IN_RESOURCE
State 6: START_STORE_RESOURCE_CONTAINER_INFO_IN_WORKSPACE_MEDATA_REPOSITORY
State 7: END_STORE_RESOURCE_CONTAINER_INFO_IN_WORKSPACE_MEDATA_REPOSITORY

Here, during the transition between states 2 and 3, resource metadata, such as name, owner etc., is stored in the workspace metadata repository 115. During the transition 176 between states 6 and 7, the ID of the workspace container in the resource, is stored in the workspace metadata repository 115. This ID is used later for accessing the resource from inside the workspace.

The state transitions 176 can be simplified if the operation log 146 and the workspace metadata are kept in the same repository 115. In this case, the log 146 and the workspace 150 metadata repository 115 may be updated in a single SQL-transaction, reducing the possibility for errors. For instance, the resource metadata and the log entry for state 3 can be stored in a single SQL-transaction. This way, the log entry for state 2 is not needed and the absence of the log entry for state 3 implies that resource metadata was also not stored in the workspace metadata repository. Thus, the state transition diagram presented above can be reduced to the following if the log and workspace metadata are updated in a single SQL-transaction:
State 1: START_ADD_DISCUSSION_RESOURCE
State 2: STORED_RESOURCE_METADATA_IN_WORKSPACE_MEDATA_REPOSITORY
State 3: START_CREATE_WORKSPACE_CONTAINER_IN_RESOURCE
State 4: END_CREATE_WORKSPACE_CONTAINER_IN_RESOURCE
State 5: STORED_RESOURCE_CONTAINER_INFO_IN_WORKSPACE_MEDATA_REPOSITORY
   Here, the resource metadata and the log entry for state 2 are stored in a single SQL-transaction.

For simplicity, assume that the operation log 146 and workspace 150 metadata are kept in the same repository 115 and hence, can be updated in a single SQL-transaction. With each log entry, optional information specific to a particular execution sequence of the operation can be stored. This information can be used (for instance) in deciding how to recover from a failure. For simplicity, we will not show such information in the operation logs presented below.

When an operation 162 fails, before returning control to the user 120, an entry for the state NEEDS_RECOVERY is stored in the operation log 146 to indicate that the system needs to recover from this operation. A fault is primarily detected by the presence of NEEDS_RECOVERY entry for an operation in the log 146. However, the system may crash before it is able to store the NEEDS_RECOVERY entry in the log. In this case, a timeout interval is used to detect the failed operation; if the time of last modification of the last log entry for the operation is earlier than the timeout interval, the status of the operation is considered to be in-doubt. It is left to the system administrator to determine whether it is safe to execute recovery procedure for an in-doubt operation or not.

An example of fault processing according to the system in FIG. 3 will now be discussed to further illustrate recovering from a fault. After the fault is detected, one of the following two schemes can be used for recovering from the fault, as discussed above with respect to step 319:

I. Rollback based recovery: In this scheme, the log is scanned backwards and a compensating step is executed for each state transition encountered. For instance, for the example discussed above, suppose the operation fails after state 3 such that the log has the following four entries for the operation:
State 1: START_ADD_DISCUSSION_RESOURCE
State 2: STORED_RESOURCE_METADATA_IN_WORKSPACE_METADATA_REPOSITORY
State 3: START_CREATE_WORKSPACE_CONTAINER_IN_RESOURCE
Error state: NEEDS_RECOVERY
   This means a fault occurred during the transition between states 3 and 4, and the workspace container in the resource may or may not have been created. The following steps are now performed to compensate for the state transitions made so far, which effectively delete the resource from the workspace:

1. Start recovery: A log entry for the state RECOVERING is stored for the operation. This log entry indicates that recovery process is being executed for the operation.

2. Rollback the transition between states 3 and 4: Delete the workspace container in the resource. Since a resource container ID had not been stored in the workspace metadata repository in the storage repository 115 before the fault occurred, we need use the workspace path name for this deletion. We assume that given a workspace path it is possible to locate the workspace container in a resource. The resource container ID identifies the workspace for the operation 162 and is stored in workspace metadata repository 115 for efficiency; this avoids round-trips to the resource for getting the resource container ID. Based on the information in the operation log, it is not possible to determine whether the resource container was created or not before the fault occurred. So, the attempt to delete the resource container may return an “object not found” exception. Such an exception is ignored because it means the resource container was not created before the fault occurred. The same is generally true about any delete operation performed during recovery.

3. Rollback the transition between states 2 and 3: Delete the log entry for state 3.

4. Rollback the transition between states 1 and 2: In a single SQL-transaction, delete the resource metadata in workspace metadata repository and the log entry for state 2.

5. Rollback the start of the operation: Delete the log entries for states 1 and RECOVERING. Note that this step can be combined with the previous step.

If any of the steps performed during recovery fails, then the recovery process can be restarted from the point of last failure, using the remaining log entries. For example, suppose the workspace metadata repository crashes after completing step 3 of recovery (i.e., rollback the transition between states 2 and 3) but before completing step 4. When the recovery operation is executed again after restarting the workspace metadata repository, only the remaining two steps (i.e., steps 4 and 5) of the recovery process are executed to complete recovery.

II. Completion based recovery: In this scheme, the last state transition recorded in the operation log is read and each of the remaining state transitions is executed to complete the operation. For instance, for the example discussed above, suppose the operation fails after state 2 such that the log has the following three entries:
State 1: START_ADD_DISCUSSION_RESOURCE
State 2: STORED_RESOURCE_METADATA_IN_WORKSPACE_METADATA_REPOSITORY
Error state: NEEDS_RECOVERY
   This means a fault occurred during the transition between states 2 and 3, and the workspace container in the resource was not created. The following steps are now performed to complete the remaining state transitions required to complete the operation of adding discussion resource in the workspace:

1. Start recovery: A log entry for the state RECOVERING is stored for the

TABLE I

| | Compatible/incompatible operations | | | | | |
|---|---|---|---|---|---|---|
| Last log entry for the | a. Add | b. Delete | c. Access | d. Add | e. Delete | f. Access |
| current fault | discussion | discussion | discussion | document | document | document |
| (operation, state) | resource | resource | resource | library | library | library |
| a. (Add | Disallowed | Disallowed | Disallowed | Allowed | Allowed | Allowed |
| discussion | | | | | | |
| resource, any | | | | | | |
| state)* | | | | | | |
| b. (Delete | Disallowed | Disallowed | Disallowed | Allowed | Allowed | Allowed |
| discussion | | | | | | |
| resource, any | | | | | | |
| state)* | | | | | | |
| d. (Add | Allowed | Allowed | Allowed | Disallowed | Disallowed | Disallowed |
| document | | | | | | |
| library, any | | | | | | |
| state)* | | | | | | |
| e. (Delete | Allowed | Allowed | Allowed | Disallowed | Disallowed | Disallowed |
| document | | | | | | |
| library, any | | | | | | |
| state)* | | | | | | |

(*Any state except a terminal (completion) state)

operation. This log entry indicates that recovery process is being executed for the operation.

2. Execute the transition between states 2 and 3: Store a log entry for state 3.

3. Execute the transition between states 3 and 4: First create the workspace container in the resource and then store a log entry for state 4.

4. Execute the transition between states 4 and 5: First, store the ID of the resource container (obtained in step 3 above) in the workspace metadata repository, and then store a log entry for state 5.

5. End recovery: Delete the log entry for the state RECOVERING stored in step 1.

The compatibility logic 148 provides fault tolerance by selectively allowing only operations which will not interfere with a possibly inconsistent state resulting from a fault and persisting until completion of recovery. An operation compatibility matrix 186, shown in an exemplary manner in Table I, may be employed for allowing/disallowing operations in the presence of a fault. For each operation-state combination, this matrix stores which other operations 162 are disallowed with this combination. The current log 146 entries and this operation compatibility matrix are consulted to determine whether the request for an operation should be allowed or disallowed. For example, consider the following operations on a workspace 150:
a. Add discussion resource
b. Delete discussion resource
c. Access discussion resource
d. Add document library
e. Delete document library
f. Access document library
   Table I illustrates one possible operation compatibility matrix for the above operations on a workspace 150.

The compatibility matrix is a flexible scheme because the definition of the matrix determines the restrictions imposed in the presence of a fault. For example, another alternative definition of the operation compatibility matrix for the above example is a matrix whose every entry is “Disallowed”. After a fault occurs in a workspace, this alternative operation compatibility matrix will disallow all operations in the workspace until recovery is performed for the last operation.

Accordingly, alternate configurations need not explicitly store all the entries in the operation compatibility matrix. Since it is a Boolean matrix, only entries that have the value false (or alternatively, true) need to be stored. Moreover, this matrix is likely to be sparse; so any suitable technique for storing sparse matrices can be used for storing this matrix. Strictly speaking the definition of each column/row in the operation compatibility matrix includes information about the parameters of the operation. For instance, in the matrix given above, each row and column definition includes the workspace on which the operation is being performed. But each possible parameter value need to be explicitly stored in the matrix; instead, such information can be stored in a parameterized form, e.g., in the Table I matrix, the symbol current_workspace can be used to refer to the current workspace being employed.

Concurrent execution of operations simultaneously issued by multiple users may lead to faults. The compatibility matrix 186 is also employed to avoid such race conditions. For instance, suppose one user is adding a discussion resource to a workspace and another user is trying to access this resource in the workspace. If these two operations are not synchronized, the second user may see partially populated resource metadata stored in workspace metadata repository. The operation log and an operation compatibility matrix are used to detect such race conditions. Strictly speaking the operation compatibility matrix for avoiding faults need not be same as the operation compatibility matrix for tolerating faults (described above). But, for simplicity, we will assume these two operation compatibility matrices are identical, except the column (operation, state) applies to both ongoing and failed operations. This approach is better than using database (session/transaction) locks because in a multi-tier Internet architecture (due to issues such as middle-tier database connection pooling) maintaining such locks for the entire duration of distributed operation is difficult and may adversely affect scalability and reliability.

Those skilled in the art should readily appreciate that the programs and methods for performing fault tolerance in a collaboration environment as defined herein are deliverable to a processing device in many forms, including but not limited to a) information permanently stored on non-writeable storage media such as ROM devices, b) information alterably stored on writeable storage media such as floppy disks, magnetic tapes, CDs, RAM devices, and other magnetic and optical media, or c) information conveyed to a computer through communication media, for example using baseband signaling or broadband signaling techniques, as in an electronic network such as the Internet or telephone modem lines. The operations and methods may be implemented in a software executable object or as a set of instructions embedded in a carrier wave. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and method for performing fault tolerance in a collaboration environment has been particularly shown and described with references to embodiments thereof, it will be understood by those skilled in the art that various changes in form and details may be made therein without departing from the scope of the invention encompassed by the appended claims.

What is claimed is:

1. A method of performing fault tolerance in a collaboration environment comprising:
identifying a plurality of segments of an operation, each segment indicative of partial completion of the operation;
defining a state corresponding to each segment;
performing each of the segments in the order defined by the states; and
transitioning to a recovery state if performing a segment results in an incomplete result.

2. The method of claim 1 wherein each of the segments corresponds to an update to a particular repository from among the plurality of repositories included in the operation.

3. The method of claim 2 wherein performing the segments further comprises writing to a state log, the state log operable to identify the state of the operation as at least one of successfully completed, just failed and ongoing.

4. The method of claim 3 further comprising identifying a state definition indicative of, for each state, a next state for success and failure transitions, a failure transition corresponding to a recovery state.

5. The method of claim 4 wherein transitioning to a recovery state further comprises selecting between completion based recovery and rollback based recovery.

6. The method of claim 5 wherein performing the rollback based recovery further comprises:
reverting to the last completed state; and
performing a compensating step for each completed state to achieve consistency for the compensated step.

7. The method of claim 1, further comprising defining recovery logic operable to identify, from a particular current state, a transition state for advancement.

8. The method of claim 7 wherein identifying the transition state further comprises:
storing a current state;
referencing a state definition indicative of the next state based on a particular current state;
updating a state log upon completion; and
transitioning to the referenced next state.

9. The method of claim 8 wherein the state definition defines a deterministic state of the operation from each state based on the outcome of the previous state.

10. The method of claim 9 wherein each of the segments corresponds to a repository update, performing the segment further comprising writing the corresponding update to the repository.

11. The method of claim 10 further comprising defining a plurality of states corresponding to segments, the segments indicative of predetermined demarcations of a portion of the entire operation, the predetermined demarcations indicative of partial completion of the operation.

12. The method of claim 11 wherein partial completion is indicative of storing the updates in a subset of a plurality of repositories corresponding to the entire operation.

13. The method of claim 12 further comprising:
writing the completed state to a state log; and
storing the state log and the update corresponding to the segment in the same volume such that a single SQL statement is operable to update both.

14. The method of claim 12 further comprising, in the event of partial completion of an operation:
identifying concurrent operations being attempted during recovery of a partial completion;
computing if the identified concurrent operation is compatible with the partial completion; and
selectively disallowing the concurrent operation if it is not compatible with the partial completion.

15. The method of claim 1 wherein the states define a nonlinear finite state machine, at least one of the states corresponding to a conditional transition based on completion of a predetermined set of data repositories.

16. A fault tolerant collaboration server operable in a collaboration environment comprising:
a fault processor operable to identify a plurality of segments of an operation, each segment indicative of partial completion of the operation;
a state definition operable to define a state corresponding to each segment, the collaboration server operable to perform each of the segments in the order defined by the states; and
recovery logic operable to transition to a recovery state if performing a segment results in an incomplete result.

17. The server of claim 16 wherein each of the segments corresponds to an update to a particular repository from among the plurality of repositories included in the operation.

18. The server of claim 17 further comprising a state log indicative of completed segments, wherein the recovery logic is further operable to write to a state log, the state log operable to identify the states as at least one of successfully completed, just failed and ongoing.

19. The server of claim 18 wherein the state log is further operable to identify a state definition indicative of, for each state, a next state for success and failure transitions, a failure transition corresponding to a recovery state.

20. The server of claim 19 wherein the recovery logic is further operable to select between completion based recovery and rollback based recovery during transition to a recovery state.

21. The server of claim 20 wherein the recovery logic is further operable to performing the rollback based recovery by:
reverting to the last completed state; and
performing a compensating step for each completed state to achieve consistency for the compensated step.

22. The server of claim 21 wherein the recovery logic is further operable to:
write the completed state to a state log; and
store the state log and the update corresponding to the segment in the same volume such that a single SQL statement is operable to update both.

23. The server of claim 22 further comprising compatibility logic operable to, in the event of partial completion of an operation:
identify concurrent operations being attempted during recovery of a partial completion;
compute if the identified concurrent operation is compatible with the partial completion; and
selectively disallow the concurrent operation if it is not compatible with the partial completion.

24. A computer program product having a computer readable medium operable to store computer program logic embodied in computer program code encoded thereon, the computer program code receivable by a processor for executing computer program instructions for performing fault tolerance in a collaboration environment comprising:
computer program code for identifying a plurality of segments of an operation, each segment segments corresponding to an update to a particular repository from among the plurality of repositories included in the operation;
computer program code for defining a state corresponding to each segment;
computer program code for performing each of the segments in the order defined by the states; and
computer program code for transitioning to a recovery state if performing a segment results in an incomplete result.

25. A computing device for performing fault tolerance in a collaboration environment comprising:
means for identifying a plurality of segments of an operation, each segment indicative of partial completion of the operation;
means for defining a state corresponding to each segment;
means for performing each of the segments in the order defined by the states; and
means for transitioning to a recovery state if performing a segment results in an incomplete result, each of the segments corresponding to an update to a particular repository from among the plurality of repositories included in the operation; and
means for writing to a state log, the state log indicative of segment completion and operable to identify the state of the operation as at least one of successfully completed, just failed and ongoing.
